(19) United States
(12) Patent Application Publication
(10) Pub. No.: US 2007/0201872 A1
(43) Pub. Date: Aug. 30, 2007

(54) IP triple play over Gigabit Ethernet passive optical network

(75) Inventors: Philip Yim, Petaluma, CA (US); Francesco Salamida, Milano (IT); EuJin Lim, San Jose, CA (US); Tommy Long, Cary, NC (US); Ronald B. Houck III, Apex, NC (US); Gary Shearin, Raleigh, NC (US)

Correspondence Address: ARENT FOX PLLC, 1050 CONNECTICUT AVENUE, N.W., SUITE 400, WASHINGTON, DC, 20036, US

(73) Assignee: Allied Telesis Holdings K.K.

(21) Appl. No.: 11/655,272

(22) Filed: Jan. 19, 2007

Related U.S. Application Data
(60) Provisional application No. 60/759,956, filed on Jan. 19, 2006.

(51) Int. Cl. H04J 14/00

(52) U.S. Cl. 398/66

(57) ABSTRACT

A method and system for providing Triple Play services using GE-PON technology on a conventional network system, including coupling VLAN bridging to an optical line termination unit by dedicating a GE-PON logical link for each one of voice, data and video as inputs and outputs of the optical line termination unit, and coupling VLAN bridging to each optical network terminal by dedicating a GE-PON logical link for each one of voice, data and video as inputs and outputs of each optical network terminal, wherein a signal out of each optical network terminal is routed to a residential gateway that comprises a dedicated GE-PON logical link for each one of voice, data and video.

This application claims priority from provisional application No. 60/759,956, filed on Jan. 19, 2006, which is incorporated herein in its entirety.

### BACKGROUND OF THE INVENTION

1. Field of the Invention

The present invention relates to networking technologies. In particular, the present inventions relates to providing Internet Protocol and Ethernet networking technologies to provide Gigabit Ethernet Passive Optical Network (GE-PON) suitable for any Triple Play applications.

2. Description of Related Art

A passive optical network (PON) is a system that brings optical fiber cabling and signals all or most of the way to the end user. Depending on where the PON terminates, the system can be described as fiber-to-the-curb (FTTC), fiber-to-the-building (FTTB), or fiber-to-the-home (FTTH). A PON consists of an Optical Line Termination (OLT) at a communication company's office and a number of Optical Network Units (ONUs) located near end users. Typically, up to 32 ONUs can be connected to an Optical Line Termination. The passive aspect of the PON simply describes the fact that optical transmission has no active electronic parts once the signal is being transmitted through the network.

A Gigabit Ethernet Passive Optical Network (GE-PON) is a point-to-multipoint protocol per the IEEE 802.3 standard, in that one physical port emits packets to multiple Ethernet ports without active electronics in-between. In the downstream direction, all the devices on the network can receive the signal transmitted, so the Customer Premise Equipment (CPE) must select only the content it is supposed to receive. In the upstream direction, only the OLT can detect the signal transmitted by the Customer Premise Equipment. Therefore, the OLT must coordinate the Customer Premise Equipment so that the medium can be shared efficiently. Because it is a shared medium, bandwidth has to be allocated for each service and each subscriber on the shared medium.

Multiple users of a GE-PON can share portions of the bandwidth. A PON can also serve as a trunk between a larger system, such as a Cable TV system, and a neighborhood, building, or home Ethernet network on a coaxial cable.

However, as fiber-only Ethernet speed reaches more than 10 Gbps, there is a need to establish a GE-PON as the choice of network technology that combines the Ethernet and the benefits of PON architectures for delivering high-speed voice, data and video services (i.e., Triple Play) to entities such as residential and business subscribers.

Furthermore, providers such as telephone companies, need to provide more than legacy voice services, and many telephone companies have the goal to provide Triple Play services in order to increase revenues, especially since Triple Play services have already been implemented using Digital Subscriber Lines (DSL). Other telephone companies may prefer to use GE-PON to deliver Triple Play services without an analog overlay. Virtual Local Area Network (VLAN) bridging has been used for delivering packet-based Triple Play services to consumers via last mile technology. VLAN bridging is packet-based and independent of the last mile technology, and is already in use in Digital Subscriber Lines. However, VLAN Bridging is not in use in GE-PON systems.

Accordingly, VLAN bridging works using point-to-point technology. GE-PON is by definition is a point-to-multipoint technology, but also supports logical links, which can be point-to-point as well as point-to-multipoint. In order to provide triple play, Quality of Service (QoS) also has to be performed. VLAN bridging provides its form of QoS, and logical links provides another form of QoS.

### SUMMARY OF THE INVENTION

In light of the above described problems and shortcomings as well as others, various exemplary embodiments according to this invention provide methods and systems for providing Triple Play services using GE-PON technology on a conventional point-to-multipoint network system. The methods and systems of embodiments of the present invention provide coupling VLAN bridging to an optical line termination unit by dedicating a GE-PON logical link for each one of voice, data and video as inputs and outputs of the optical line termination unit, and coupling VLAN bridging to each multipoint Optical Network Terminal (ONT) by dedicating a GE-PON logical link for each one of voice, data and video as inputs and outputs of each multipoint ONT, wherein a signal out of each ONT is routed to a residential gateway that comprises a dedicated VLAN for each one of voice, data and video.

Additional advantages and novel features of the invention will be set forth in part in the description that follows, and in part will become more apparent to those skilled in the art upon examination of the following or upon learning by practice of the invention.

### BRIEF DESCRIPTION OF DRAWINGS

Various exemplary embodiments of the systems and methods will be described in detail, with reference to the following figures, wherein:

FIG. 1 illustrates an exemplary method for providing Triple Play services using GE-PON technology on a conventional point-to-multipoint network system;

FIG. 2 illustrates and exemplary system for providing Triple Play services using GE-PON technology on a conventional point-to-multipoint network system;

FIG. 3 is a block diagram of various exemplary system components, in accordance with an embodiment of the present invention; and

FIG. 4 presents an exemplary system diagram of various hardware components and other features, for use in accordance with an embodiment of the present invention.

### DETAILED DESCRIPTIONS OF PREFERRED EMBODIMENTS

These and other features and advantages of this invention are described in, or are apparent from, the following detailed description of various exemplary embodiments of the systems and methods according to this invention.

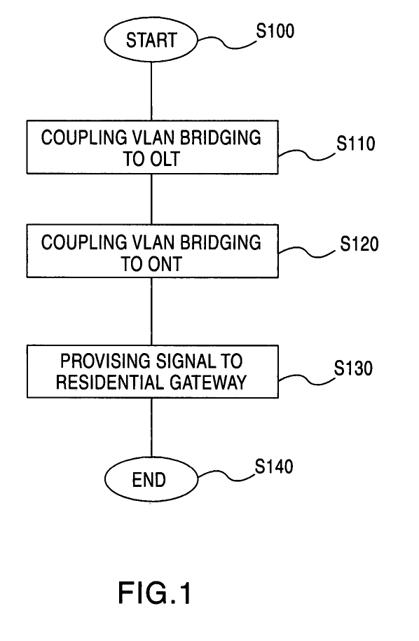

FIG. 1 illustrates an exemplary method for providing Triple Play services using GE-PON technology on a conventional point-to-multipoint network system. In FIG. 1, the method starts at step S100, and continues to step S110, where a conventional optical line terminal unit is functionally coupled to a VLAN bridge. According to various exemplary embodiments, coupling the Optical Line Termination to a VLAN bridge includes providing the Optical Line Termination with a plurality of dedicated point-to-point logical links, one of which is dedicated to voice, another to data, and yet another to video, and the logical links dedicated to voice, data and video, which may also be point-to-multipoint logical links may be dedicated to each ONT. There is also a point-to-multipoint logical link.

Next, control continues to step S120, during which one or more of the ONT's that constitute the conventional network may also be functionally coupled to a VLAN bridge. According to various exemplary embodiments, coupling the one or more ONT's to a VLAN bridge includes providing each ONT with a plurality of dedicated logical links, one of which is dedicated to voice, another to data, and yet another to video. Next, control continues to step S130, during which a signal is provided, for example, to a residential gateway. According to various exemplary embodiments, the signal may be provided via a plurality of dedicated logical links, one of them dedicated to voice, another dedicated to data, and yet another logical link dedicated to video. Next, control continues to step S140, where the method ends.

Thus, among other things, the present invention relates to a system and method of allowing service providers to transition from a copper-based last mile network to a fiber-based infrastructure, while eliminating active electronics from the OSP by using, for example, a residential gateway as a converter.

An alternative to other systems, the present invention of the Triple Play over GE-PON provides symmetrical data rates of 32Mbps, for example, and ensures that sufficient bandwidth is available for moderate consumer or business requirements.

A VLAN Bridge may be coupled to the OLT, to and ONT, by mapping a VLAN to GE-PON logical links. Mapping a VLAN Bridge to logical links may be accomplished by, for example, having each VLAN use only one logical link to each ONU for unicast Ethernet packets that are “known” by the Bridge to be destined to that ONU. Accordingly, normal VLAN Bridging at the OLT determines downstream which ONU(s) to transmit packets to. If traffic is destined to one ONU, then a dedicated logical link may be used. It may be noted that in downstream directions, it may be wasteful to replicate traffic that is intended for a plurality of subscribers. It is generally more efficient to send a packet once, have each ONT receive the traffic, and then ignore the packet if the packet is not destined for the particular ONT. If downstream traffic for a VLAN is destined to multiple subscribers such as, for example, multicast or broadcast Ethernet packets, as well as unicast packets whose ONU destination are “un-known” by the OLT Bridge), then traffic will use a shared multipoint logical link.

In the case of upstream traffic, each VLAN may use only one logical link to arrive at the OLT. According to various exemplary embodiments, VLAN Bridging may use such indicators as 802.1 p bits, to denote the quality of service that a packet is to obtain. Thus, once a VLAN and its logical link have been identified, the indicators may be used to determine if the traffic may be delayed because of lower priority, or be immediately sent because of high priority.

According to various exemplary embodiments, the quality of service process may include making a decision as to which logical link to use, and checking quality of service indicators relative to other packets already queued to determine whether the packets may be sent earlier or later, depending on the relative indicators.

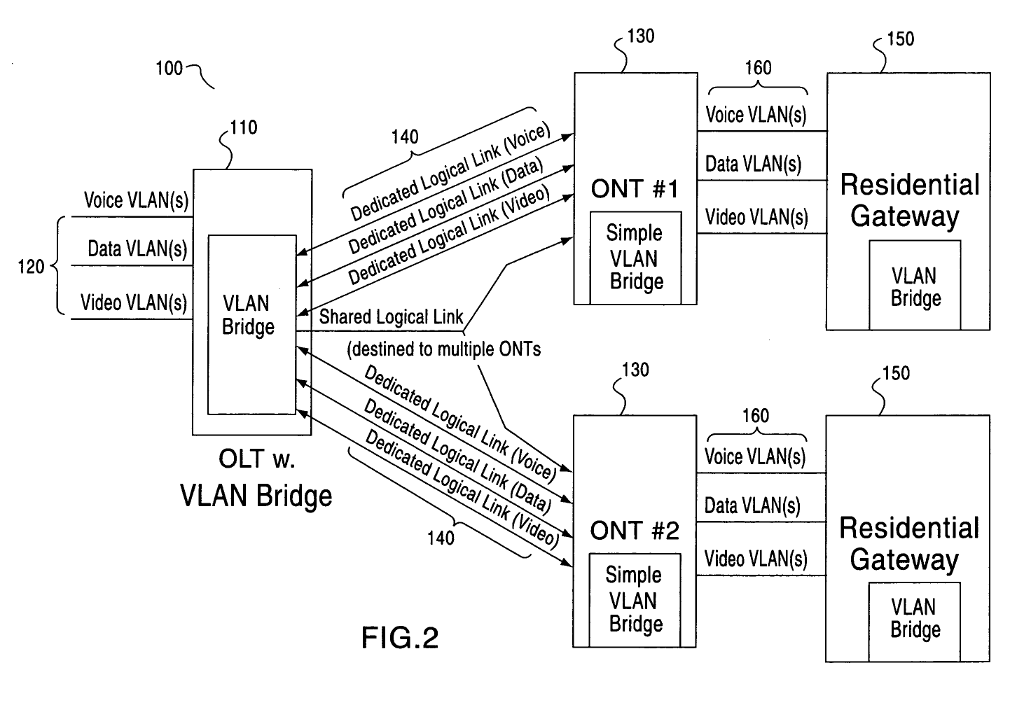

FIG. 2 illustrates an exemplary system for providing Triple Play services using GE-PON technology on a conventional point-to-multipoint network system. In FIG. 2, a conventional OLT is functionally coupled to a VLAN bridge to form and VLAN-bridged OLT 110, and the OLT 110 may be configured to receive as inputs a plurality of dedicated VLANs 120, each of the VLANs 120 being dedicated to voice, another to data, and yet another to video. According to various exemplary embodiments, the OLT 110 may output a signal to a plurality of ONT's 130 via a plurality of dedicated logical links 140, wherein one of the dedicated logical links 140 may be dedicated to voice, another to data, and yet another to video. According to various exemplary embodiments, one or more of the plurality of ONT's 130 may provide a signal to a residential gateway 150, and the signal may be provided via a plurality of dedicated VLANs 160, wherein one of the dedicated VLANs 160 may be dedicated to voice, another to data, and yet another to video.

The exemplary embodiment of the present invention can be implemented in hardware, software, or a combination of both hardware and software and may be implemented in one or more computer based systems or other packet processing systems such as LAN or WAN systems, communications networks, and wireless/mobile network systems. In particular, the present exemplary invention can be directed toward one or more computer based systems capable of carrying out the functionality described herein or can be in an integrated, modular, and single chip solution and can be embodied on a semiconductor substrate, such as an Application Specific Integrated Circuit (ASIC).

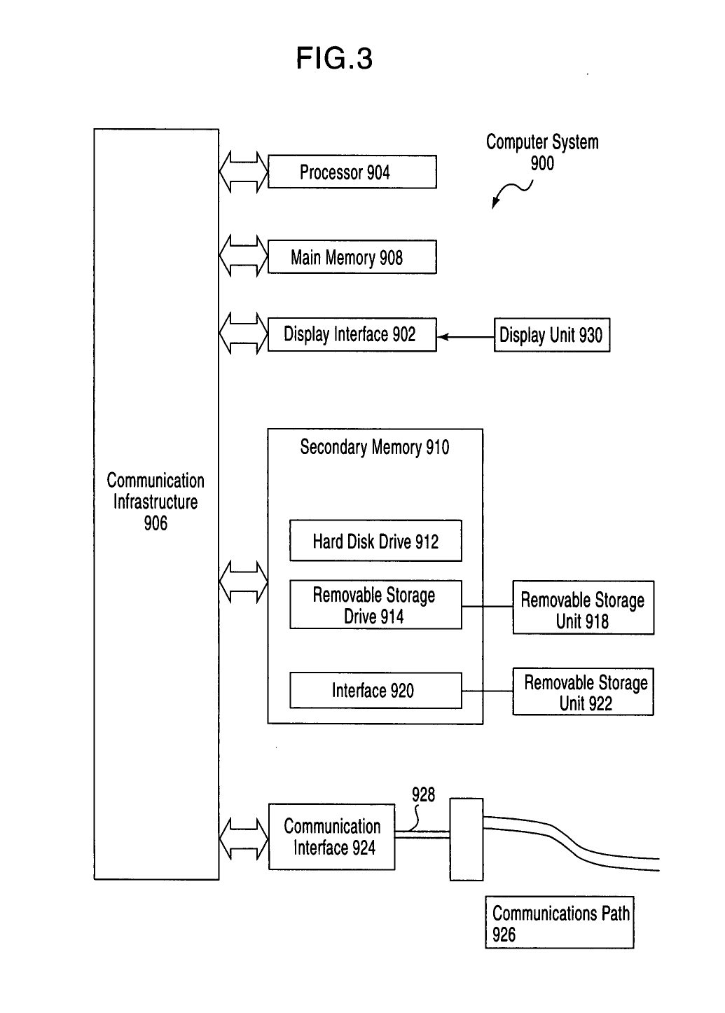

The present invention may also be implemented using hardware, software, or a combination thereof and may be implemented in one or more computer systems or other processing systems. In one embodiment, the invention is directed toward one or more computer systems capable of carrying out the functionality described herein. An example of such a computer system 900 is shown in FIG. 3.

Computer system 900 includes one or more processors, such as processor 904. The processor 904 is connected to a communication infrastructure 906 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an embodiment where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

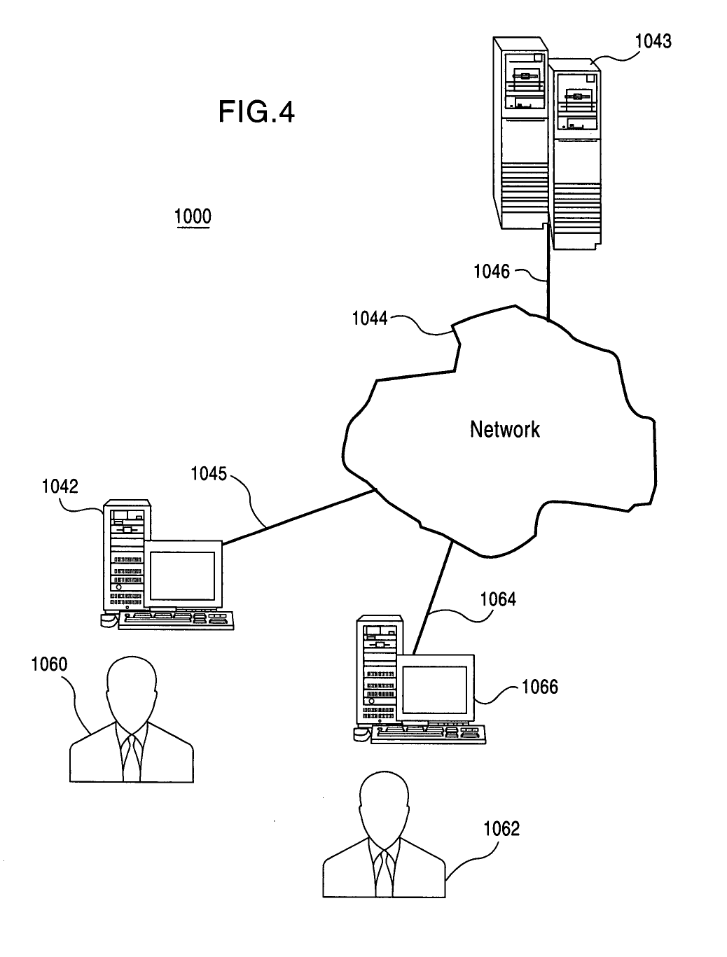

FIG. 4 shows an exemplary communication system 1000 usable in accordance with the various features of the present invention. The communication system 1000 includes one or more accessors 1060, 1062 (also referred to interchangeably herein as one or more “users”) and one or more terminals 1042, 1066. In one embodiment, data for use in accordance with the present invention is, for example, input and/or accessed by accessors 1060, 1064 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another embodiment, the method and system of the present operate in a standalone environment, such as on a single terminal.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method of providing Triple Play services using Gigabit Ethernet Passive Optical Network technology on a conventional network, the method comprising:
coupling VLAN bridging to an optical line termination unit by dedicating at least one VLAN for at least one of voice, data and video as at least one input and at least one output of the optical line termination unit; and
coupling VLAN bridging to each optical network terminal on the conventional network by dedicating a logical link for at least one of voice, data and video as at least one input and at least one output of each optical network terminal;
wherein a signal out of any optical network terminal is routed to a residential gateway that comprises a dedicated VLAN for each of the at least one of voice, data and video.

2. The method of claim 1, wherein VLAN bridging is coupled to the optical line termination unit by dedicating a logical dedicated link to each of voice, data and video.

3. The method of claim 1, wherein VLAN bridging is coupled to each optical network terminal by dedicating a logical link for to each of voice, data and video.

4. The method of claim 1, wherein the signal out of each optical network terminal is routed to a residential gateway that comprises a VLAN for each of voice, data and video.

5. The method of claim 1, wherein dedicating a logical link while coupling VLAN bridging to an optical line termination unit comprises dedicating a Gigabit Ethernet Passive Optical Network logical link.

6. The method of claim 1, wherein dedicating a logical link while coupling VLAN bridging to each optical network terminal comprises dedicating a Gigabit Ethernet Passive Optical Network logical link.

7. The method of claim 1, wherein routing the signal out of each optical network terminal to the residential gateway comprises dedicating an Ethernet link.

8. A system for providing Triple Play services using Gigabit Ethernet Passive Optical Network technology on a conventional network, the system comprising:
means for coupling VLAN bridging to an optical line termination unit by dedicating a logical link for at least one of voice, data and video as at least one input and at least one output of the optical line termination unit; and
means for coupling VLAN bridging to each optical network terminal of the conventional network by dedicating a logical link for at least one of voice, data and video as at least one input and at least one output of each optical network terminal;
wherein a signal out of any optical network terminal is routed to a residential gateway that comprises a dedicated logical link for at least one of voice, data and video.

9. The system of claim 8, wherein at least one of the dedicated logical links is a Gigabit Ethernet Passive Optical Network logical link.

10. The system of claim 8, wherein the means for coupling VLAN bridging to the optical line termination unit dedicate a logical link to each of voice, data and video.

11. The system of claim 8, wherein the means for coupling VLAN bridging to each optical line termination unit dedicate a logical link to each of voice, data and video.

12. The system of claim 8, wherein each optical network terminal is routed to the residential gateway that comprises a dedicated logical link for each one of voice, data and video.

13. A machine-readable medium that provides instructions for providing Triple Play services using Gigabit Ethernet Passive Optical Network technology on a conventional network system, the instructions, when executed by a processor, cause the processor to perform operations comprising:
coupling VLAN bridging to an optical line termination unit by dedicating a Gigabit Ethernet Passive Optical Network logical link for each one of voice, data and video as at least one input and at least one output of the optical line termination unit; and
coupling VLAN bridging to each optical network terminal of the conventional network by dedicating a Gigabit Ethernet Passive Optical Network logical link for each one of voice, data and video as at least one input and at least one output of each Optical Network Terminal;
wherein a signal out of any optical network terminal is routed to a residential gateway that comprises a dedicated Gigabit Ethernet Passive Optical Network logical link for each one of voice, data and video.

14. The system of claim 8, the system comprising:
a processor;
a user interface functioning via the processor; and
a repository accessible by the processor.

15. The system of claim 14, wherein the processor is housed on a terminal selected from a group consisting of a personal computer, a minicomputer, a main frame computer, a microcomputer, a hand held device, and a telephonic device.

16. The system of claim 14, wherein the processor is housed on a server selected from a group consisting of a personal computer, a minicomputer, a microcomputer, and a main frame computer.

17. The system of claim 16, wherein the server is coupled to a network via a coupling selected from a group consisting of a wired connection, a wireless connection, and a fiber-optic connection.

18. A system for providing Triple Play services using Gigabit Ethernet Passive Optical Network technology on a conventional network, the system comprising:
a VLAN bridge coupled to an optical line termination unit by dedicating a logical link for at least one of voice, data and video as at least one input and at least one output of the optical line termination unit; and
a VLAN bridge coupled to each optical network terminal of the conventional network by dedicating a logical link for at least one of voice, data and video as at least one input and at least one output of each optical network terminal;
wherein a signal out of any optical network terminal is routed to a residential gateway that comprises a dedicated logical link for at least one of voice, data and video.

19. The system of claim 18, wherein at least one of the dedicated logical links is a Gigabit Ethernet Passive Optical Network logical link.

20. The system of claim 18, wherein the VLAN bridge coupling to the optical line termination unit dedicates a logical link to each of voice, data and video.

21. The system of claim 18, wherein the VLAN bridge coupling to each optical line termination unit dedicates a logical link to each of voice, data and video.

22. The system of claim 18, wherein each optical network terminal is routed to the residential gateway that comprises a dedicated logical link for each one of voice, data and video.

23. The method of claim 1, wherein the optical network terminal is known.

24. The method of claim 1, wherein
the optical network terminal is unknown,
the optical network terminal is mapped to a point-to-multipoint logical link, and
an identification is provided by a VLAN coupling bridge.

25. The method of claim 24, wherein a decision is made as to whether to forward the VLAN to the residential gateway on the basis of the identification.
